(19) United States
(12) Patent Application Publication
(10) Pub. No.: US 2025/0118784 A1
(43) Pub. Date: Apr. 10, 2025

(54) Membrane Electrode Assembly for High Temperature PEM Fuel Cells and Water Electrolysis

(71) Applicant: HyWatts Inc., Wilmington, DE (US)

(72) Inventors: Aleksei Ivanenko, Danville, CA (US); Dietmar Trees, San Diego, CA (US); Artem Riazantsev, San Diego, CA (US); Alexander Todorov, Puerto de la Cruz (ES); Samuel Emil Ruben, Sausalito, CA (US)

(21) Appl. No.: 18/907,535

(22) Filed: Oct. 6, 2024

Related U.S. Application Data
(60) Provisional application No. 63/542,963, filed on Oct. 6, 2023.

(51) Int. Cl. H01M 8/1034; C25B 9/23; C25B 13/08; H01M 8/10; H01M 8/1004; H01M 8/1032; H01M 8/1039; H01M 8/1053; H01M 8/1067

(52) U.S. Cl. CPC H01M 8/1034; C25B 9/23; C25B 13/08; H01M 8/1004; H01M 8/1032; H01M 8/1039; H01M 8/1053; H01M 8/1067; H01M 2008/1095; H01M 2300/0082; H01M 2300/0094

(57) ABSTRACT

A membrane electrode assembly is provided for mitigating the detrimental effect of water or steam on HTPEM membranes. The membrane electrode assembly includes an ion conductive electrolyte membrane, an ion conductive interface layer, a cathode electrode and an anode electrode. The electrolyte membrane is laminated with the ion conductive interface layer on both the cathode side and the anode side or on only one side. The ion conductive interface layer includes a material having sufficiently high ion conductivity and a chemically stable structure to withstand the effect of the elevated temperatures and water. These ion conductive interface layers act as an effective barrier to electrolyte on the membrane side and to the water on the electrode side, while only marginally effecting the overall ion of the electrode conductivity because of the thinness of the layer.

### RELATED APPLICATION DATA

This application claims the benefit of priority of U.S. Provisional Patent Application Ser. No. 63/542,963, filed Oct. 6, 2023, and titled Membrane Electrode Assembly Structure for High Temperature PEM Fuel Cells and Water Electrolysis, which is incorporated by reference herein in its entirety.

### FIELD OF THE DISCLOSURE

The present disclosure generally relates to the field of reversible fuel cell systems. In particular, the present disclosure is directed to a membrane electrode assembly for high temperature proton exchange membrane (PEM) fuel cells and water electrolyzers.

### BACKGROUND

There are three primary water electrolysis technologies that are utilized for hydrogen production for potential increases in the performance and durability required for high-capacity green hydrogen production. These are low temperature PEM electrolysis, anion exchange membrane electrolysis, and Solid Oxide Cell (SOC) electrolysis.

The first two technologies operate at temperatures, i.e., below 100° C., and use liquid water as a reactant, which limits the efficiency of the electrolyzer cell and requires treatment of the water prior to use in the electrolyzer. SOC technology operates at temperatures around 600° C. to 800° C. and tends to experience material degradation challenges, and tends to require complex and energy demanding start and stop conditions.

High temperature (also referred to as medium temperature) PEM (HTPEM) fuel cells, which operate at temperatures from 100° C. to 250° C., are based on acid electrolyte containing polymer membranes (e.g., polybenzimidazole (PBI), quaternary ammonium grafted polyphenols). Operation at these elevated temperatures allows for improved kinetics of the redox reactions of the cell and simplification of the cooling system and water management, as a broader temperature range can be supported, and water can be produced and consumed in gaseous form. Both of these factors make HTPEM fuel cells potentially useful for various applications, such as in power generation systems of heavy-duty vehicles and marine and aerospace applications. However, such power demanding applications require the fuel cells to operate at high current densities, resulting in the generation of significant amounts of water, which detrimentally influences the performance and durability of the fuel cells.

Use of these membranes of HTPEM systems for the reverse process, i.e., electrolysis and generation of hydrogen from water, is advantageous due to the simplification and cost reduction of the electrolyzer, but at the same time has not been widely adopted commercially because of the expected rapid degradation of the membrane and catalyst layers in the required operating conditions: elevated temperatures and the exposure to oxygen in air, corrosive membrane electrolytes, and steam.

### SUMMARY OF THE DISCLOSURE

A membrane electrode assembly for high temperature proton exchange membrane fuel cells and water electrolyzers includes an ion conductive electrolyte membrane doped with phosphoric acid, an ion conductive interface layer having an ion conductive electrolyte membrane side and an electrode side, a cathode, and an anode. The ion conductive interface layer is between the ion conductive electrolyte membrane and one of the cathode and the anode and is configured to provide an effective barrier for electrolyte on the ion conductive electrolyte membrane side and for water on the electrode side. A second ion conductive layer may be included and the ion conductive interface layer is between the ion conductive electrolyte membrane and the cathode and the second ion conductive interface layer is between the ion conductive electrolyte membrane the anode.

Further, a membrane electrode assembly for high temperature proton exchange membrane fuel cells and water electrolysis includes a proton exchange membrane containing an electrolyte, a cathode, an anode, a first ion conductive interface layer that contains no electrolyte between the proton exchange membrane and the cathode, and a second ion conductive interface layer that contains no electrolyte between the proton exchange membrane and the anode.

### BRIEF DESCRIPTION OF THE DRAWINGS

For the purpose of illustrating the disclosure, the drawings show aspects of one or more embodiments of the disclosure. However, it should be understood that the present disclosure is not limited to the precise arrangements and instrumentalities shown in the drawings, wherein:

FIG. 1 is a schematic view illustrating component layers of a membrane electrode assembly in accordance with an embodiment of the present disclosure;

FIG. 2 is a schematic view illustrating component layers of a membrane electrode assembly in accordance with another embodiment of the present disclosure; and

FIG. 3 is a schematic view illustrating component layers of a membrane electrode assembly in accordance with another embodiment of the present disclosure.

### DETAILED DESCRIPTION

The drawbacks of using HTPEM fuel cells in water-rich conditions outlined above relate to the membrane. The electrolyte of the membrane exhibits ionic and hydrogen-type bonding to the functional groups of the polymer, which in the required operating conditions can be lower in energy than the electrolyte bonding to the water molecules. The exposure of this type of membrane to water or steam leads to washing of the electrolyte out of the polymer and, as a consequence, to a reduction of the proton conductivity of the membrane and thinning of the membrane. The thinning of the membrane leads to the loss of current flow contact between the membrane and electrodes of the cell and, as a consequence, to an increase of the ohmic losses and a decrease in power output of the cell.

Membrane electrode assemblies for PEM fuel cells typically are either “fully dry”, in which both the polymeric membrane and the polymeric ionomer in the catalyst layers do not include phosphoric acid solution, or are “fully wet”, in which phosphoric acid solution is present in both the polymeric membrane and the catalyst layers (which are typically integrated with the electrode).

A membrane electrode multilayer structure of the present disclosure mitigates the detrimental effect of water or steam on the integrity and performance of HTPEM membranes while maintaining the performance of the membrane by including phosphoric acid in the proton exchange membrane and coating that proton exchange membrane (on one or both sides) with an ion conductive interface layer that does not include phosphoric acid, such that the ion conductive interface layer is disposed between the proton exchange membrane and the electrode (either the anode, the cathode, or both).

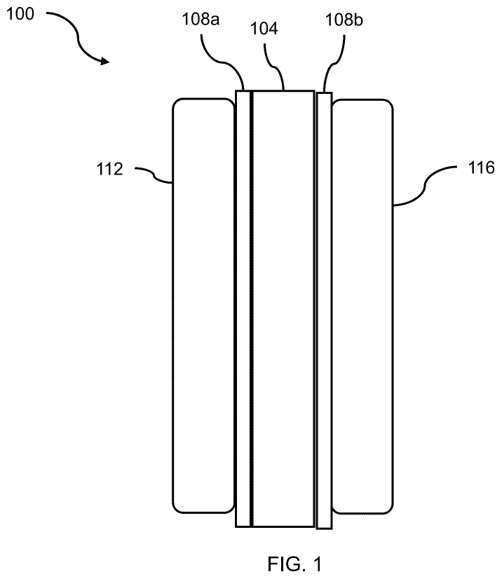

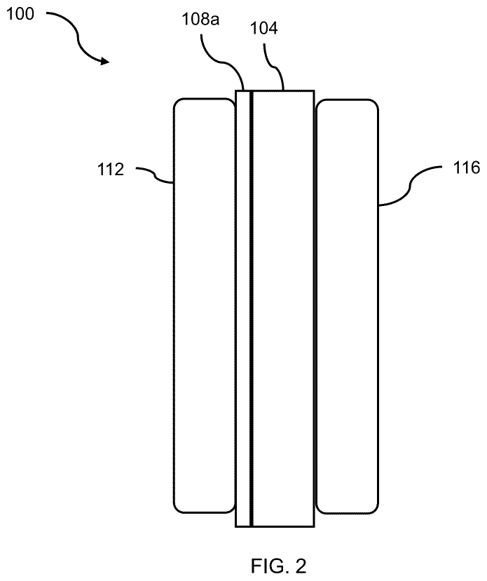

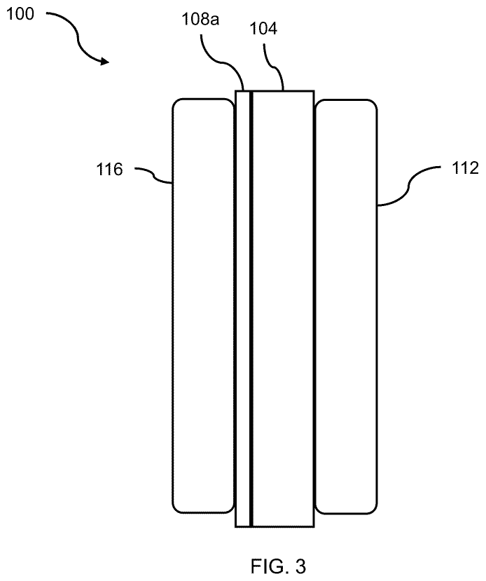

Exemplary embodiments a membrane electrode assemblies are illustrated schematically in FIGS. 1-3. A membrane electrode assembly (MEA) 100 includes an ion conductive electrolyte membrane 104 (i.e., the proton exchange membrane), one or two ion conductive interface layers 108 (e.g., 108a, 108b), a cathode 112 and an anode 116 (the cathode and anode can include catalyst layers). The electrolyte membrane 104 is laminated with the ion conductive interface layer 108 on both the cathode side and the anode side (as shown in FIG. 1) or on only one side (as shown in FIGS. 2 (cathode side) and 3 (anode side)) of membrane 104. Alternatively, the cathode and/or anode may be coated with the ion conductive interface layer on the side that interfaces with the proton exchange membrane.

The ion conductive interface layer 108 comprises a material having sufficiently high ion conductivity and a chemically stable structure to withstand the effect of the elevated temperature and interaction with phosphoric acid solution and water in any form (i.e., steam, gas, liquid). Examples of such interface layer materials include, but are not limited to, sulphonated (sulphonic groups branched) or phosphonated (phosphonic groups branched) polymers (e.g., PBI, perfluoropolystyrene, polyphenylsulphone (PPSU), fluoroelastomers, or fluoro rubber material (FKM)). Preferably, the ion conductive interface layer does not contain electrolyte solutions, such as phosphoric acid. The ion containing groups of these polymers are bonded to the polymer backbone by high energy bonds so they are not mobilized by the water under the conditions experienced during operation of HTPEM systems. On other hand, the presence of water and saturation of the polymer of the ion conductive interface during HTPEM operation leads to additional protonation and an increase of the ion conductivity of the interface layer.

The use of such ion conductive interface polymers as a standalone membrane is limited due to the low ion conductivity of membranes having sufficient thicknesses to be a self-supporting material layer. However, when used as a thin film of ion conductive interface on one or both sides of the proton exchange membrane as described herein, and thus supported by the highly conductive electrolyte membrane (or electrode surface), ion conductive interface polymers act as an effective barrier for the electrolyte on the membrane side and for the water on the electrode side, while only marginally effecting the overall ion conductivity due to being a thin layer, e.g., preferably from the submicron level (e.g., 0.5 micrometers) to about 50 micrometers.

The polymer of the ion conductive interface layer can be also used as an ionomer of the catalytic layer of the electrodes, providing a synergetic positive addition to the performance of the MEA due to the materials compatibility and conjunction.

The ion conductive interface can be applied or bonded either on the membrane or electrode surface or can be used as an individual layer of the membrane electrode assembly.

The layer of the ion conductive interface can be formed by a range of forming methods and processes, such as spray coating, dip coating, powder coating, screen-printing, blade coating, thermal spraying, sol-gel, spin-coating, brush coating, extruding, plasma deposition, or surface grafting techniques.

The term “about” when used with a corresponding numeric value refers to ±20% of the numeric value, typically +10% of the numeric value, often ±5% of the numeric value, and most often ±2% of the numeric value. In some embodiments, the term “about” can be taken as exactly indicating the actual numerical value.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present disclosure.

What is claimed is:

1. A membrane electrode assembly for high temperature proton exchange membrane fuel cells and water electrolyzers, comprising:
an ion conductive electrolyte membrane doped with phosphoric acid;
an ion conductive interface layer having an ion conductive electrolyte membrane side and an electrode side;
a cathode; and
an anode,
wherein the ion conductive interface layer is between the ion conductive electrolyte membrane and one of the cathode and the anode and is configured to provide an effective barrier for electrolyte on the ion conductive electrolyte membrane side and for water on the electrode side.

2. The membrane electrode assembly of claim 1, further including a second ion conductive layer, wherein the ion conductive interface layer is between the ion conductive electrolyte membrane and the cathode and the second ion conductive interface layer is between the ion conductive electrolyte membrane the anode.

3. The membrane electrode assembly of claim 1, wherein the ion conductive interface layer has a thickness of between about 0.5 microns and about 50 microns.

4. The membrane electrode assembly of claim 1, wherein the ion conductive interface layer is made of a polymer selected from the group of sulphonated polymers, phosphonated polymers and fluoroelastomers.

5. The membrane electrode assembly of claim 4, wherein the polymer used for the interface layer is perfluoropolystyrene or polyphenylsulphone.

6. The membrane electrode assembly of claim 1, wherein the ion conductive interface layer is bonded to a surface of the ion conductive electrolyte membrane.

7. The membrane electrode assembly of claim 1, wherein the ion conductive interface layer is bonded to a surface of the anode.

8. The membrane electrode assembly of claim 1, wherein the ion conductive interface layer is bonded to a surface of the cathode.

9. The membrane electrode assembly of claim 1, wherein the ion conductive interface layer does not contain an electrolyte solution.

10. A membrane electrode assembly for high temperature proton exchange membrane fuel cells and water electrolysis, comprising:
a proton exchange membrane containing an electrolyte;
a cathode;
an anode;
a first ion conductive interface layer between the proton exchange membrane and the cathode, wherein the first ion conductive interface layer contains no electrolyte; and
a second ion conductive interface layer between the proton exchange membrane and the anode, wherein the second ion conductive interface layer contains no electrolyte.

11. The membrane electrode assembly of claim 10, wherein the second ion conductive layer is sized and positioned to prevent direct contact between the proton exchange membrane and the anode and the first ion conductive interface layer is sized and positioned to prevent direct contact between the proton exchange membrane the cathode.

12. The membrane electrode assembly of claim 11, wherein the first ion conductive interface layer has a thickness of between about 0.5 microns and about 50 microns and the second ion conductive interface layer has a thickness of between about 0.5 microns and about 50 microns.

13. The membrane electrode assembly of claim 12, wherein the first and second ion conductive interface layers are made of a polymer selected from the group of sulphonated polymers, phosphonated polymers and fluoroelastomers.

14. The membrane electrode assembly of claim 13, wherein the polymer is perfluoropolystyrene or polyphenylsulphone.

15. The membrane electrode assembly of claim 11, wherein the first ion conductive interface layer is bonded to the proton exchange membrane.

16. The membrane electrode assembly of claim 11, wherein the first ion conductive interface layer is bonded to the cathode.

17. The membrane electrode assembly of claim 15, wherein the second ion conductive interface layer is bonded to the proton exchange membrane.

18. The membrane electrode assembly of claim 16, wherein the second ion conductive interface layer is bonded to the anode.

19. The membrane electrode assembly of claim 10, wherein the first ion conductive interface layer has a proton exchange membrane side and a cathode side and is configured to provide an effective barrier for electrolyte on the proton exchange membrane side and for water on the cathode side.

20. The membrane electrode assembly of claim 19, wherein the second ion conductive interface layer has a proton exchange membrane side and an anode side and is configured to provide an effective barrier for electrolyte on the proton exchange membrane side and for water on the anode side.
